(19) United States
(12) Patent Application Publication
(10) Pub. No.: US 2026/0281700 A1
(43) Pub. Date: Sep. 17, 2026

(54) METHODS, ARCHITECTURES, APPARATUSES AND SYSTEMS FOR LEVERAGING DIRECT LINKS TO IMPROVE FEDERATED LEARNING TRAINING PROCESS IN FUTURE WIRELESS

(71) Applicant: InterDigital Patent Holdings, Inc., Wilmington, DE (US)

(72) Inventors: Chonggang Wang, Princeton, NJ (US); Xu Li, Plainsboro, NJ (US); Robert Gazda, Spring City, PA (US); Ulises Olvera-Hernandez, Saint-Lazare (CA)

(21) Appl. No.: 19/167,204

(22) PCT Filed: Mar. 27, 2024
(86) PCT No.: PCT/US2024/021600

§ 371 Date: Sep. 19, 2025

Related U.S. Application Data
(60) Provisional application No. 63/456,100, filed on Mar. 31, 2023.

(51) Int. Cl. H04W 8/22; G06N 3/098; G06N 20/00; H04W 48/14; H04W 88/04

(52) U.S. Cl. CPC H04W 8/22; G06N 3/098; G06N 20/00; H04W 48/14; H04W 88/04

(57) ABSTRACT

Procedures, apparatuses, and computer program products that leverage direct links to improve FL training processes in wireless networks are provided. One method may include sending, to a network node, a request for other WTRU(s) to serve as a relay WTRU for the first WTRU, and receiving information on one or more candidate relay WTRUs in proximity of the first WTRU. Based at least on the received information, the method may include selecting at least one of the candidate relay WTRUs to serve as the relay WTRU, performing a discovery procedure with the selected relay WTRU(s), sending a direct communication request to the selected relay WTRU(s), performing the current local training round to generate a new local model update, and sending, to the selected relay WTRU(s), at least a portion of the new local model update and/or an identifier of a FL task associated with the new local model update.

### CROSS-REFERENCE TO RELATED APPLICATIONS

This application claims the benefit of U.S. Provisional Patent Application No. 63/456,100, filed Mar. 31, 2023, which is incorporated herein by reference in its entirety.

### FIELD

The present disclosure is generally directed to the fields of communications, software and/or encoding, including, for example, to methods, architectures, apparatuses, and/or systems related to leveraging direct links to improve federated learning (FL) training processes in wireless networks.

### BACKGROUND

Federated learning (FL) is a framework for distributed machine learning. In Federated learning (FL), training data may be maintained locally at multiple distributed Federated Learning Clients (FLCs), such as user or mobile devices. A FLC may perform local training, generate local model updates, and/or send local model updates to a Federated Learning Server (FLS).

### SUMMARY

An embodiment may be directed to a first WTRU that comprises circuitry, including any of a processor, memory, transmitter and/or receiver. The circuitry is configured to send, to a network node, first information indicating a request for at least one other WTRU to serve as a relay WTRU for the first WTRU, and to receive, from the network node, second information indicating one or more candidate relay WTRUs in proximity of the first WTRU. Based at least on the second information, the circuitry is configured to select at least one of the candidate relay WTRUs to serve as the relay WTRU for the first WTRU. The circuitry may be configured to perform, according to a discovery mode, a discovery procedure with the at least one selected relay WTRU, to send third information indicating a direct communication request to the at least one selected relay WTRU, to perform a local training round to generate a new local model update, and to send fourth information, to the at least one selected relay WTRU, indicating at least a portion of the new local model update and an identifier of a FL task associated with the new local model update.

An embodiment may be directed to a method, implemented by a first wireless transmit/receive unit (WTRU). The method may include sending, to a network node, first information indicating a request for at least one other WTRU to serve as a relay WTRU for the first WTRU, receiving, from the network node, second information indicating one or more candidate relay WTRUs in proximity of the first WTRU and, based at least on the second information, selecting at least one of the candidate relay WTRUs to serve as the relay WTRU for the first WTRU. The method may include performing, according to a discovery mode, a discovery procedure with the at least one selected relay WTRU, sending third information indicating a direct communication request to the at least one selected relay WTRU, performing a local training round to generate a new local model update, and sending fourth information, to the at least one selected relay WTRU, indicating at least a portion of the new local model update and an identifier of a FL task associated with the new local model update.

An embodiment may be directed to an apparatus that comprises circuitry, including at least one of a processor, memory, transmitter and receiver. The circuitry is configured to determine to select a user equipment (UE)-to-network (NW) relay for a federated learning client (FLC), and to send, to a network node, first information indicating a request for proximity information and context information associated with the FLC. The circuitry may be configured to receive, from the network node, second information indicating: (i) the proximity information and context information associated with the FLC, and (ii) one or more WTRUs in proximity of the FLC that support UE-to-NW relay services. Based at least on the second information, the circuitry is configured to select at least one of the WTRUs to serve as a UE-to-NW relay for the FLC. The circuitry may be configured to send, to the at least one of the WTRUs, third information indicating that the at least one of the WTRUs has been selected as the UE-to-NW relay for the FLC, and to receive, from the at least one of the WTRUs, a local model update associated with the FLC.

An embodiment may be directed to a method, which may include determining to select a user equipment (UE)-to-network (NW) relay for a federated learning client (FLC), and sending, to a network node, first information indicating a request for proximity information and context information associated with the FLC. The method may include receiving, from the network node, second information indicating: (i) the proximity information and context information associated with the FLC, and (ii) one or more WTRUs in proximity of the FLC that support UE-to-NW relay services. Based at least on the second information, the method may include selecting at least one of the WTRUs to serve as a UE-to-NW relay for the FLC. The method may include sending, to the at least one of the WTRUs, third information indicating that the at least one of the WTRUs has been selected as the UE-to-NW relay for the FLC, and receiving, from the at least one of the WTRUs, a local model update associated with the FLC.

An embodiment may be directed to an apparatus that comprises circuitry, including any of a processor, memory, transmitter and receiver. The circuitry is configured to determine one or more direct discovery instructions for at least one WTRU, and to send a message, to the at least one WTRU. The message may indicate or include any of: (i) the direct discovery instructions determined for the at least one WTRU, (ii) an identifier of a WTRU which is to be discovered by the at least one WTRU or which will discover the at least one WTRU, (iii) an identifier of a ProSe application server, (iv) ProSe application code and/or ProSe restricted code, and/or (v) an expiration time for each of the direct discovery instructions.

An embodiment may be directed to a method, which may include determining one or more direct discovery instructions for at least one WTRU, and sending a message to the at least one WTRU. The message may indicate or include any of: (i) the direct discovery instructions determined for the at least one WTRU, (ii) an identifier of a WTRU which is to be discovered by the at least one WTRU or which will discover the at least one WTRU, (iii) an identifier of a ProSe application server, (iv) ProSe application code and/or ProSe restricted code, and/or (v) an expiration time for each of the direct discovery instructions.

An embodiment may be directed to a wireless transmit/receive unit (WTRU) that comprises circuitry, including any of a processor, memory, transmitter and receiver. The circuitry is configured to receive a message, from a network node. The message may indicate or include direct discovery instructions determined for the WTRU, and any of: (i) an identifier of a WTRU which is to be discovered by the at least one WTRU or which will discover the at least one WTRU, (ii) an identifier of a ProSe application server, (iii) ProSe application code and/or ProSe restricted code, and/or (iv) an expiration time for each of the direct discovery instructions. The circuitry may be configured to perform direct discovery procedure according to the direct discovery instructions.

An embodiment may be directed to a method, implemented by a wireless transmit/receive unit (WTRU). The method may include receiving a message from a network node. The message may indicate or include direct discovery instructions determined for the WTRU, and any of: (i) an identifier of a WTRU which is to be discovered by the at least one WTRU or which will discover the at least one WTRU, (ii) an identifier of a ProSe application server, (iii) ProSe application code and/or ProSe restricted code, and/or (iv) an expiration time for each of the direct discovery instructions. The method may include performing direct discovery procedure according to the direct discovery instructions.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a federated learning (FL) process, according to an embodiment;

FIG. 3 is a system diagram illustrating an example of FL learning in wireless networks, according to an embodiment; and

FIG. 4 is a system diagram illustrating an example of a 5G system architecture, according to various embodiments;

FIG. 5 is a system diagram illustrating some problems relating to FL in wireless networks;

FIG. 6 is an architectural design for proximity-aware FL training process, according to various embodiments;

FIG. 7 is a signaling diagram illustrating a client-initiated proximity-aware FL training process, according to various embodiments;

FIG. 8 is a signaling diagram illustrating a server-initiated proximity-aware FL training process, according to various embodiments;

FIG. 9 is a signaling diagram illustrating a relay-initiated proximity-aware FL training process, according to various embodiments;

FIG. 10 is a signaling diagram illustrating direct discovery configuration, according to various embodiments;

FIG. 11 is a signaling diagram illustrating the configuration of periodical status reports and/or keepalive messages, according to various embodiments; and

FIG. 12 illustrates an example flow diagram of a method, according to some example embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

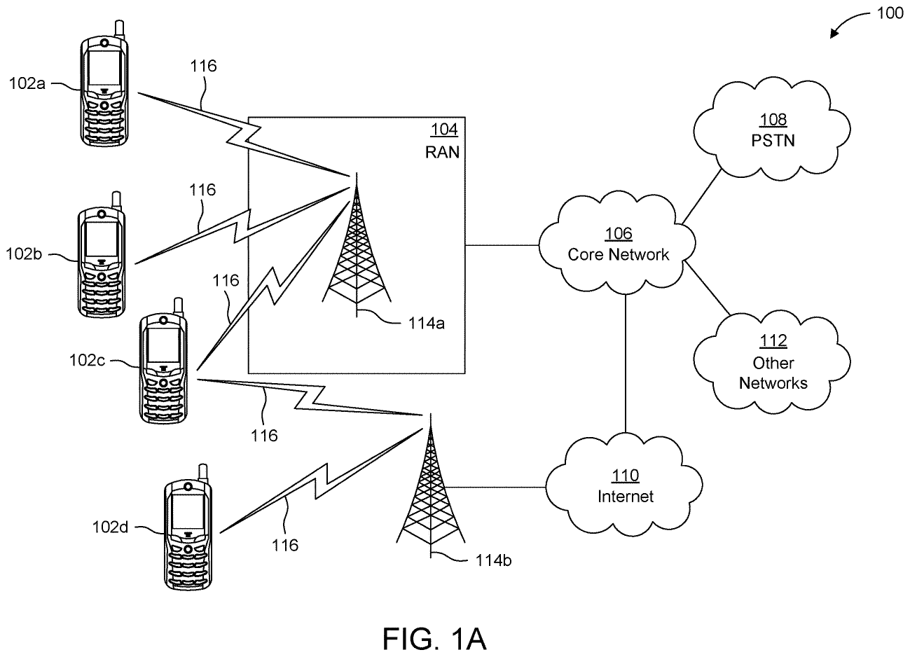

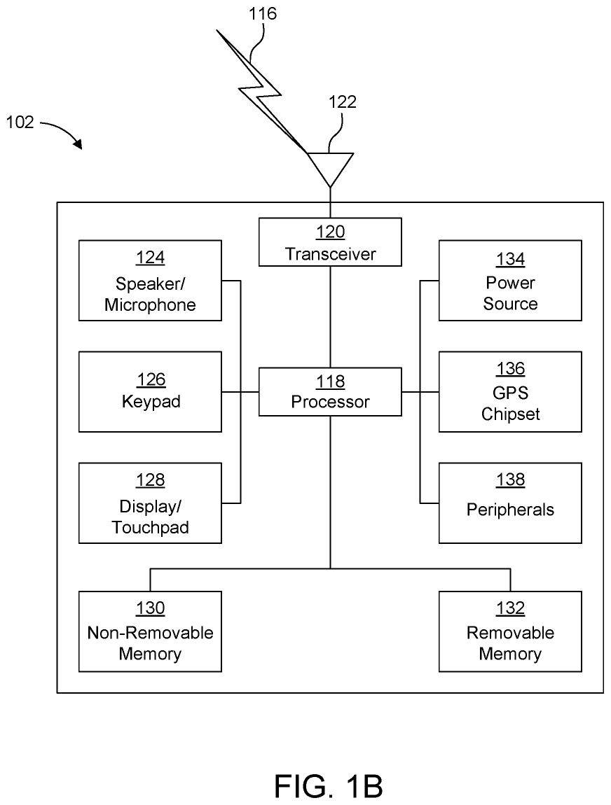

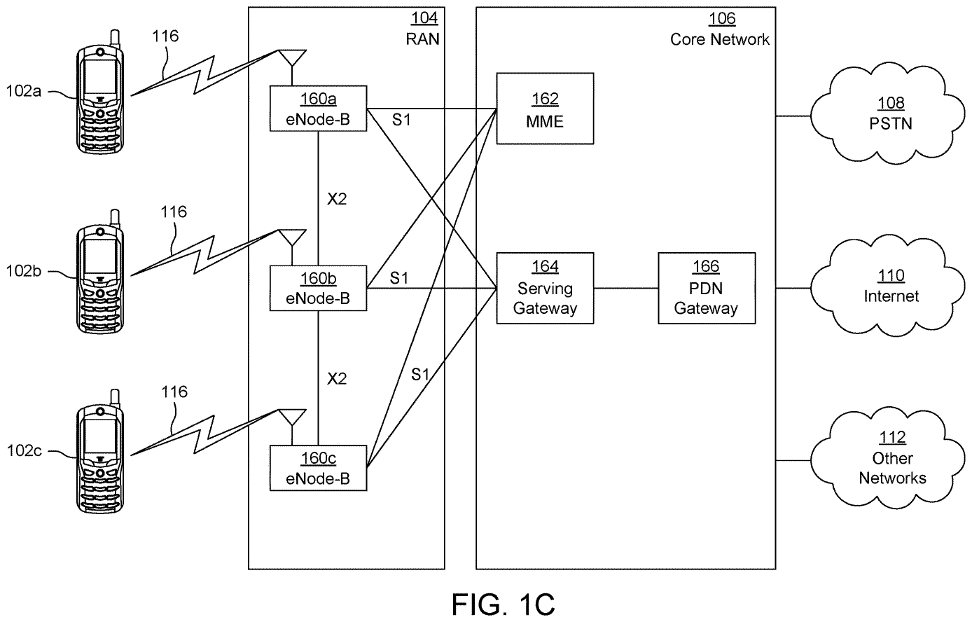

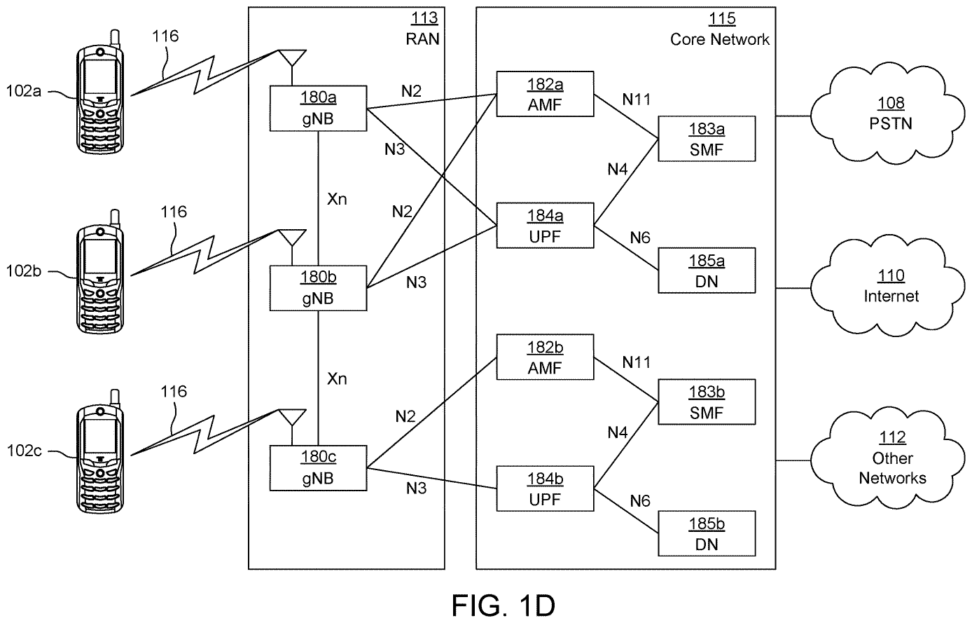

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “serving base station”, “base station”, “gNB”, collectively “gNB” may be used interchangeably to designate any network element such as, e.g., a network element acting as a serving base station. Embodiments described herein are not limited to gNBs and are applicable to any other type of base stations.

Federated Learning (FL) is a framework for distributed machine learning. In FL, training data is maintained locally at multiple distributed Federated Learning Clients (FLCs) (e.g., mobile devices). Each FLC performs local training (e.g., deep learning), generates local model updates, and sends local model updates to a Federated Learning Server (FLS) which could be an application server function or a network function in the cloud or edge, for example. The FLS aggregates local model updates received from FLCs and generates global model updates, which will be sent to the participating FLCs for the next training round. Some advantages of federated learning may include: (1) improved data privacy-preservation since training data stays at FLCs; (2) reduced communication overhead since it is not required to collect/transmit training data to a central entity; and (3) improved learning speed since model training now leverages distributed computation resources at FLCs. However, FL involves the transmission of model updates between the FLS and FLCs, which introduces additional communication overhead compared to centralized machine learning. In addition, FL inherits some potential security issues and threats such as data poisoning and model poisoning attacks.

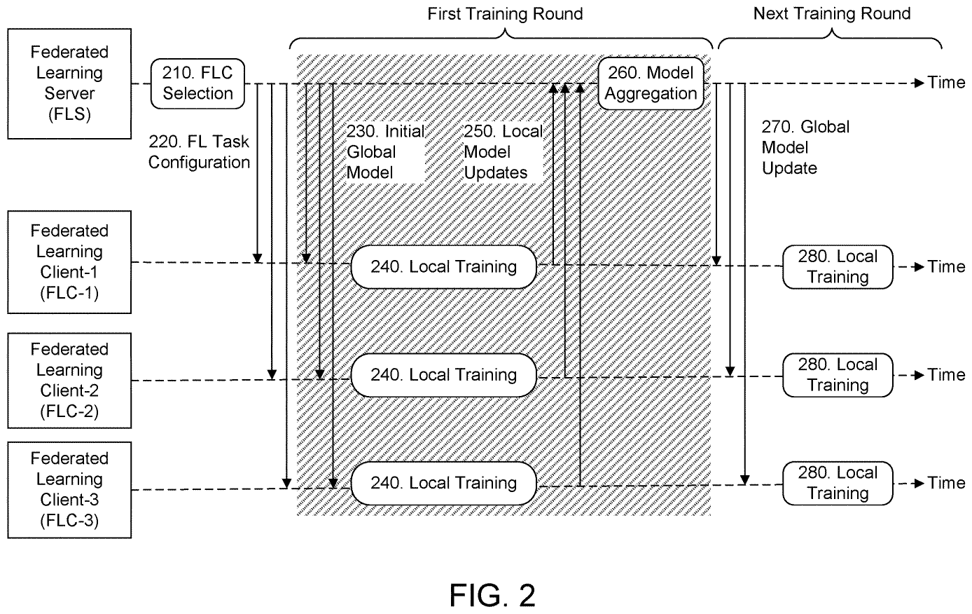

FIG. 2 illustrates an example of the general federated learning process, according to an embodiment. As illustrated in the example of FIG. 2, the FLS and FLCs may jointly take the illustrated steps to perform a FL task. At 210, the FLS may select a set of FLCs to participate in a FL task. At 220, the FLS may configure the FL task to each selected FLC. At 230, the FLS may send an initial global model to each selected FLC. At 240, one or more of the FLCs (e.g., each FLC) may independently train the global model based on the received initial global model and its local data. At 250, after each training round, one or more of the FLCs (e.g., each FLC) may generate a local model update and send it to the FLS. At 260, the FLS may receive local model updates from one or more of the FLCs (e.g., all FLCs), aggregate them, and generate a new global model update. In some embodiments, the FLS may need to wait to receive local model updates from all FLCs before performing the model aggregation (i.e., synchronous FL) or the FLS may start the aggregation after receiving the local model updates from some of FLCs (i.e., asynchronous FL). The FLS may (re) select some new FLCs for next training round. At 270, similar to step 230, the FLS may send the global model updates to one or more of the FLCs (e.g., all FLCs). At 280, similar to step 240, one or more of the FLCs (e.g., each FLC) may start the next local training.

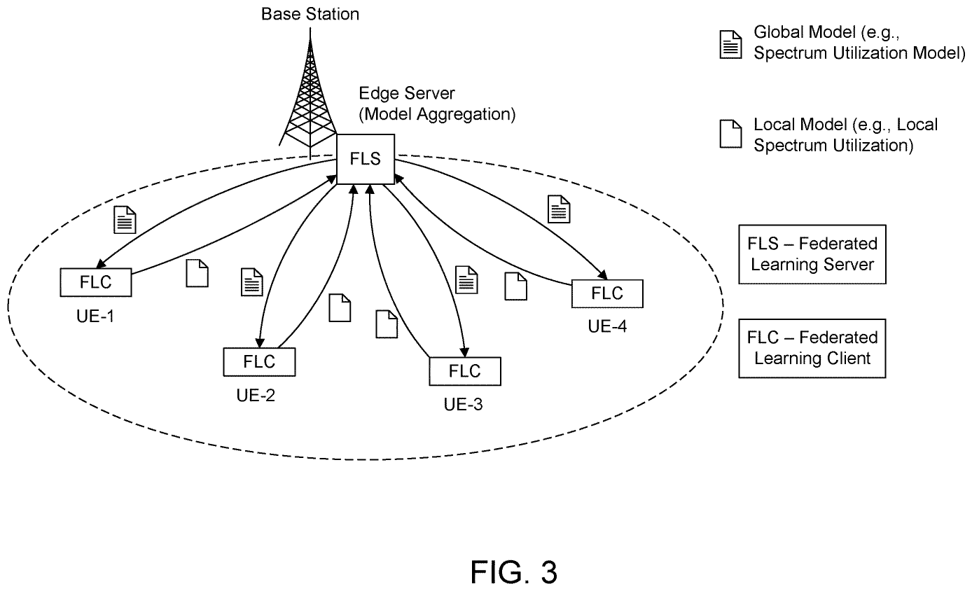

FL can be leveraged in wireless networks. For example, the FLS can be deployed in the core and/or edge, while FLCs may be end devices and/or UEs. FIG. 3 illustrates an example FL application for wireless networks, where the UEs (e.g., each UE) hosts an FLC, which collaboratively participates in training a global model.

In some embodiments, FL may be used for spectrum management. For instance, as shown in the example of FIG. 3, FL may be used to learn an accurate spectrum utilization model. In an embodiment, as illustrated in the example of FIG. 3, the UEs (i.e., UE-1, UE-2, UE-3 and UE-4) may host a FLC to generate a local model update; local model updates may be sent to an edger server, which has an FLS mainly responsible for aggregating local model updates from UEs to generate a global model update. The global model update may be sent to one or more of the UEs (e.g., all UEs) to continue the next training round until the global model converges. Then, the converged final global model may be transmitted to one or more of the UEs, which can use the final global model to manage their spectrum access.

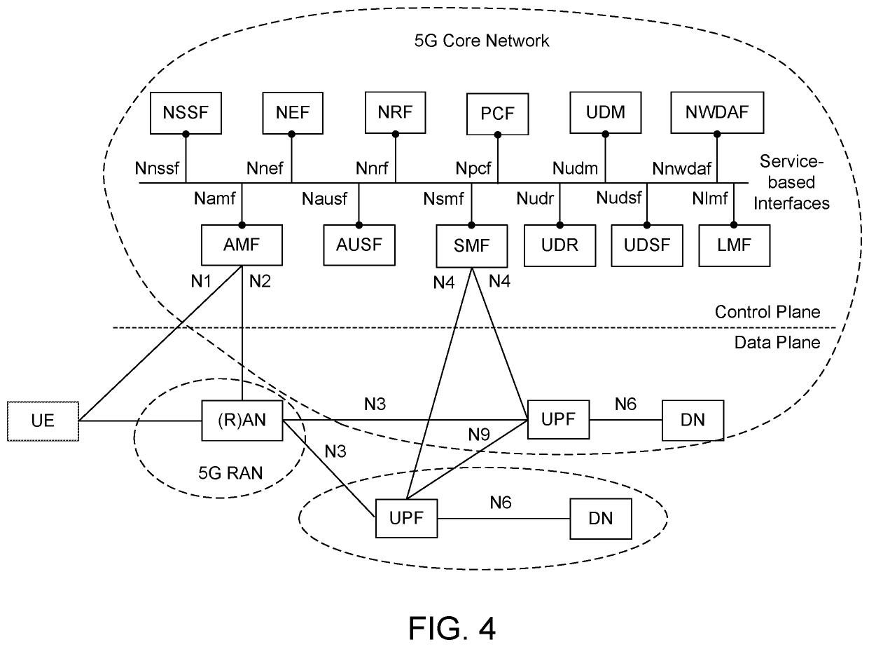

5G system architecture includes one or more UEs, Radio Access Network (RAN), and Core Network [1]. One of the design principles for the 5G system architecture is service-centric or service-based. As shown in the example of FIG. 4, 5G Core Network may contain a variety of network functions, which work together to fulfill and provide needed services to the RAN, UEs, and Application Servers/Service Providers. A network function can access other network functions in request/response mode or subscription/notification mode. Before two network functions interact with each other, they first need to register with the Network Repository Function (NRF) so that they can discover each other via the NRF. Among these network functions, Access and Mobility Management Function (AMF) is dedicated to managing UE's access to 5G System (5GS) and its mobility, Session Management Function (SMF) is responsible for establishing sessions between a UE and 5G core network, and Authentication Server Function (AUSF) takes charge of UE authentication. In addition, Policy Control Function (PCF) provides policy rules for other control plane network functions and UEs; PCF assigns an identifier for each created policy rule, which other control plane network functions and UEs use to refer to the corresponding policy rule. User Plane Function (UPF) is the only core network function in the data plane that facilitates monitoring, managing, controlling, and redirecting user plane traffic flows such as between a UE and an Application Server (AS). The Network Exposure Function (NEF) enables access to 5G control plane functions to entities such as network applications and ASs which are outside of 5G system and not in the same trusted domain. 5G core network also provides data storage and analytics services through functions like Unified Data Management (UDM), Unified Data Repository (UDR), Unstructured Data Storage Function (UDSF) and Network Data Analytics Function (NWDAF). Another critical feature of 5G system is network slicing, which is facilitated by Network Slice Selection Function (NSSF). Although these network functions are defined as separate logical entities, a particular scenario may require multiple network functions; for instance, UE mobility will need not only AMF, but also AUSF and SMF. For a type of network function, multiple instances could be instantiated and NRF will maintain the information of each instantiated network function instance. With the emergence of edge computing, some network functions in 5G Core Network such as UPF and NEF could be deployed and resided in an edge network that is much nearer to and potentially co-located with the RAN.

Some Artificial Intellgencee (AI)-related functions and services specified by 3GPP are summarized as follows. 3GPP TS 23.288 [2] defines stage-2 architecture enhancements for 5GS to support Network Data Analytics Services (NWDAF), a network function in 5G core network. Note that multiple NWDAF instances could be deployed to edge networks in future wireless systems, such as 6G. Interacting with other network functions, NWDAF provides a set of AI-related functionalities and services, some of which include: (1) data collection based on subscription to events of other network and/or application functions; (2) retrieve data and information from other network functions; (3) provide on-demand data analytics to consumers (i.e., network and/or application functions). The services provided by NWDAF can be exposed to and leveraged by other network functions in 5G core network and application functions (i.e., application servers).

3GPP TS 22.261 [3] specifies AI model transfer requirements for three types of AI operations in 5GS: (1) AI operation splitting between AI endpoints; (2) AI model/data distribution and sharing over 5GS; and (3) distributed/federated learning over 5GS. 3GPP TS 22.261 also specifies Key Performance Indicators (KPIs) for AI/ML model transfer in 5GS, specifically: (1) uplink and downlink KPIs for split AI/ML inference between UE and network server/application functions; (2) KPIs for AI/ML model downloading; and (3) KPIs for federated learning between UE and network server/application functions.

3GPP TR 23.700-80 [4] describes key issues and solutions for supporting AI/ML-based services in 5GS. The following seven key issues have been defined in 3GPP TR 23.700-80: monitoring of network resource utilization for support of application AI/ML operations; 5GC information exposure to UE; 5GC information exposure to authorized 3^{rd} party for application layer AI/ML operation; enhancing external parameter provisioning; 5GC enhancements to enable application AI/ML traffic transport; Quality of Service (QoS) and policy enhancements; and 5GS assistance to federated learning operation.

3GPP has an ongoing SA1 release-19 study item TR 22.876 [5] for the phase-2 study of AI/ML model transfer in future wireless systems. TR 22.876 has three main objectives: (1) identify the use cases for distributed AI inference; (2) identify the use cases for distributed/decentralized model training; and (3) analyze potential gaps to existing 5GS mechanism to support the distributed AI inference and model training. Especially, TR 22.876 will study and define the following aspects of distributed AI/ML: split AI/ML operation between AI/ML endpoints for AI inference by leveraging direct device connection; AI/ML model/data distribution and sharing by leveraging direct device connection; and distributed/federated learning by leveraging direct device connection.

3GPP TS 23.304 V17.4.0 (2022-09) [6] defines architecture for Proximity based Services (ProSe), where one UE acting as a relay (i.e., UE-to-Network relay or UE-to-NW relay) can connect other remote UEs being in proximity to the network. In other words, a remote UE leverages the UE-to-NW relay (another UE) to access to the 5GS. 5GS ProSe functions defined in [6] include 5G ProSe direct discovery, 5G direct communication, and 5G ProSe UE-to-Network Relay. 5G ProSe direct discovery describes the process for nearby UEs (remote UEs and UE-to-NW relays) to use direct radio transmissions to discover each other. 5G ProSe direct communication refers to the process where multiple UEs in proximity communicate with each other directly without going through any other network nodes (e.g., a base station). 5G ProSe UE-to-NW relay provides functions to support connecting one or multiple remote UEs to the network via a UE-to-Network relay.

3GPP TR 23.700-33 V1.1.0 (2022-10) [7] studies architecture enhancements to [6], such as UE-to-UE relay for unicast, enhancements of 5G ProSe UE-to-Network functionality, and path switching between direct New Radio (NR) Un communication path and direct NR PC5 communication path.

A UE-to-UE relay is a 5G ProSe-enabled UE that provides functions to and connects a remote/end UE to another remote/end UE.

Several key issues and corresponding solutions have been described in [7]. These key issues include: support of UE-to-UE relay, support of path switching between two indirect network communication paths for UE-to-Network relaying with service continuity consideration, support direct communication path switching between PC5 and Uu, support of path switching between direct network communication path and indirect network communication path for layer-2 UE-to-Network relay with session continuity consideration, support of multi-path transmission for UE-to-Network relay, support of PC5 service authorization and policy/parameter provisioning, and support of emergency for UE-to-Network relaying.

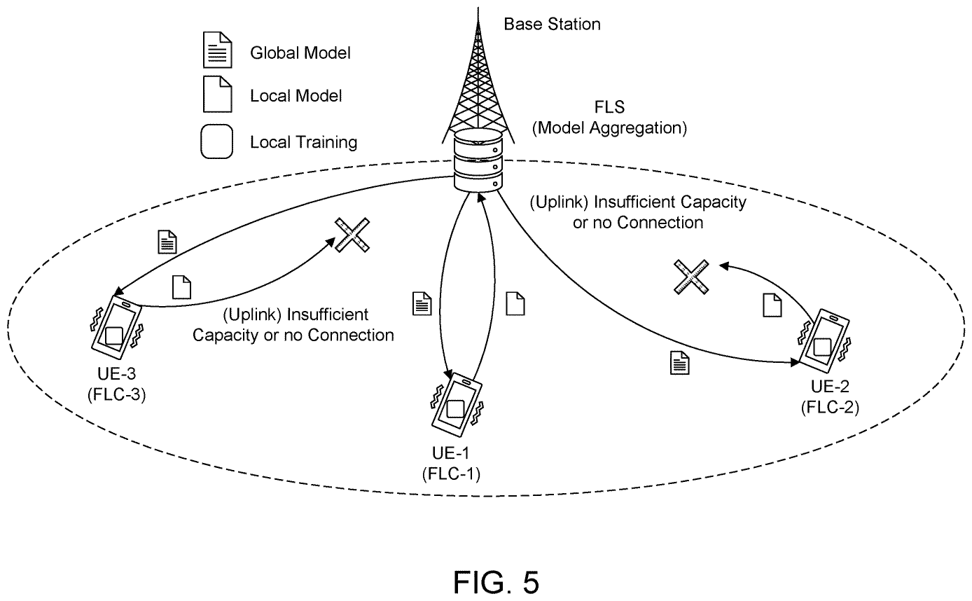

A typical FL deployment in future wireless networks may include “an FLS at the edge/core network” and “FLCs at UEs”. FIG. 5 illustrates an example of the communication-related issues that may arise in this FL over wireless deployment. As illustrated in the example of FIG. 5, the wireless connectivity between an FLC (e.g., FLC2, FLC3) and the FLS may have too limited capacity and might not support timely transmission of a local model update from this FLC to the FLS. However, in the example of FIG. 5, other nearby FLCs (e.g., FLC1) may have enough wireless capacity and operate correctly with the FLS. Thus, UEs as FLCs may lose uplink connectivity to the FLS, while other FLCs may still have connectivity to the FLS. An FLC may have limited residual energy and might not be able to finish transmitting the local model update directly to the FLS.

UEs within the same proximity could directly communicate with each other, which can in turn be leveraged to improve the FL process. For example, one UE/FLC could help to relay local model updates from another UE/FLC to the FLS. To fully leverage direct communication links among UEs/FLCs, certain specific technical issues need to be solved. These issues may include that, when an FLC runs an FL task to train an AI model, it may not have sufficient uplink communication capacity to send its local model update to the FLS. An issue that arises is how to leverage another UE as a relay to help forward the local model update from the FLC to the FLS.

In view of the above, various embodiments may provide apparatuses, systems, architectures and/or methods of leveraging direct links to improve federated learning (FL) training processes in wireless networks including future wireless systems such as, but not limited to, 6^{th} generation wireless (e.g., 6G). An embodiment may provide a proximity-aware FL training process.

As explained above, during the FL training process, an FLC (e.g., a UE) may lose the connectivity to an FLS or may not have sufficient uplink communication capacity to transmit the local model update to the FLS. Various embodiments may allow for another UE in the proximity of the FLC to be selected as a UE-to-NW relay for the FLC. Then, the FLC can continue to train the local model and sends the local model update to the relay UE, which will help forward FLC's local model update to the FLS.

Certain embodiments are directed to several enhancements to 3GPP Proximity-based Services (ProSe). For example, an enhancement may include that two (or more) UEs are configured and triggered by 3GPP network to start to discover each other using a configure discovery method. Another enhancement may include a relay UE being configured to send periodical status reports with designated information to 3GPP network.

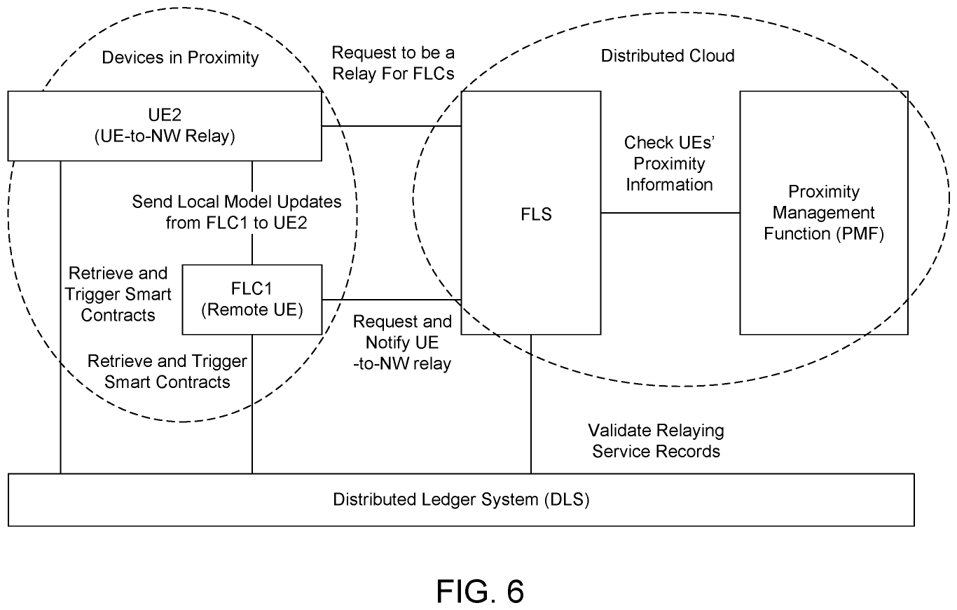

FIG. 6 illustrates an example architectural design of a proposed proximity-aware FL training process, according to certain embodiments. As illustrated in the example of FIG. 6, the architecture may include a Federated Learning Server (FLS), Federated Learning Clients (e.g., FLC1), a Proximity Management Function (PMF), a UE-to-NW relay (e.g., UE2), and optionally a Distributed Ledger System (DLS). The PMF can be a ProSe Function, a 5G Direct Discovery Name Management Function (DDNMF), a Policy Control Function (PCF), and/or an Access and Mobility Function (AMF).

In the example architecture of FIG. 6, the FLS and FLCs may be training a Federated Learning (FL) task, where FLC1 trains a local model and sends the local model update to the FLS while the FLS aggregates local model updates from FLCs to generate a global model. The global model may be sent back to FLCs for next training round until the global model achieves sufficient accuracy and/or a number of completed training rounds exceeds a preconfigured threshold. In this architecture, FLC1 may have insufficient uplink communication capacity to the base station or it may lose the connectivity to the base station. In the example of FIG. 6, UE2 is in the proximity of FLC1 and can provide UE-to-NW relay services to FLC1; in other words, after FLC1 generates a new local model, it can send the local model update to UE2, which will relay it to the FLS on behalf of FLC1. The FLS may leverage the PMF to query proximity and context information about FLCs and UE2, based on which FLS can select a UE-to-NW relay for some FLCs or select some FLCs for a given or an available UE-to-NW relay. After selecting FLC1 and UE2, the FLS may also instruct how they can discover each other and establish direct communication link between them for relaying local model updates from FLC1 to the FLS, when a new local model update is generated at FLC1. In addition, the FLS can also leverage the PMF to authenticate and/or authorize whether UE2 is allowed to provide UE-to-NW relay services.

In certain embodiments, both FLC1 and UE2 may have their own smart contacts stored in a distributed ledger (e.g., blockchain) system, which can be triggered and executed by each other; for example, UE2 can trigger to execute FLC1's smart contract and store a relay service record to the distributed ledger system each time when providing relay services to FLC1. The FLS can participate in the distributed ledger system and validate such relay service records.

The architecture in the example of FIG. 6 can support various scenarios for assigning a UE-to-NW relay to FLCs, for example: (1) when FLC1 has limited uplink communication capacity to the FLS, the FLC1 can request the FLS to assign a UE-to-NW relay; (2) when the FLS does not receive any messages from FLC1 or loses connectivity with FLC1, the FLS may actively select a UE-to-NW relay for FLC1; and/or (3) a UE-to-NW relay may indicate to the FLS about its availability and willingness to be a UE-to-NW relay for FLCs.

It is noted that the examples for proximity-aware FL training process discussed herein may focus on “UE-to-NW relay”, but example embodiments can also directly be applied to UE-to-UE relay by replacing “UE-to-NW relay” with “UE-to-UE relay,” for example when the FLS is hosted at a UE.

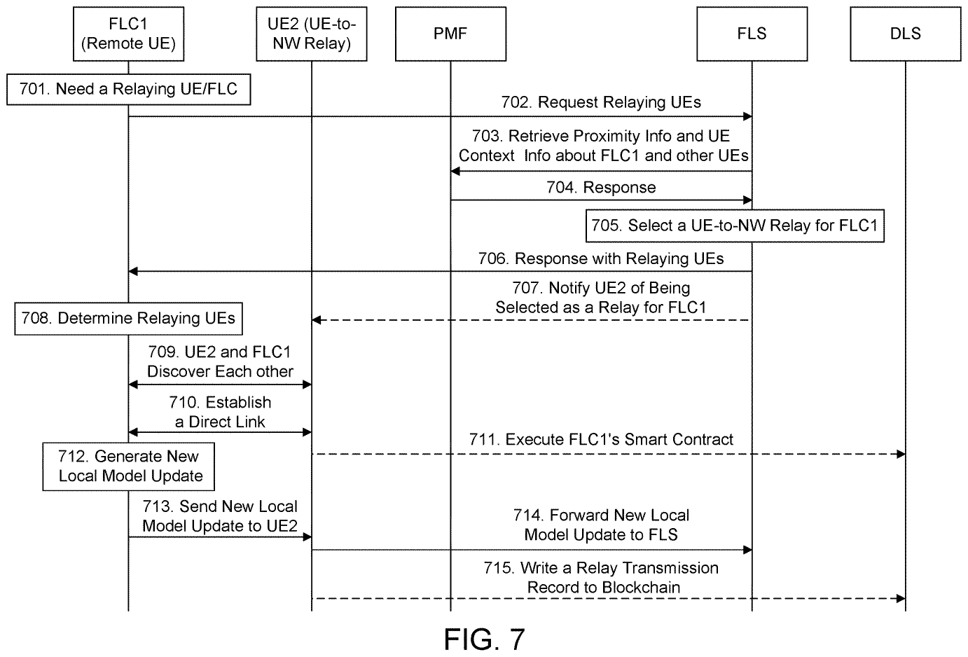

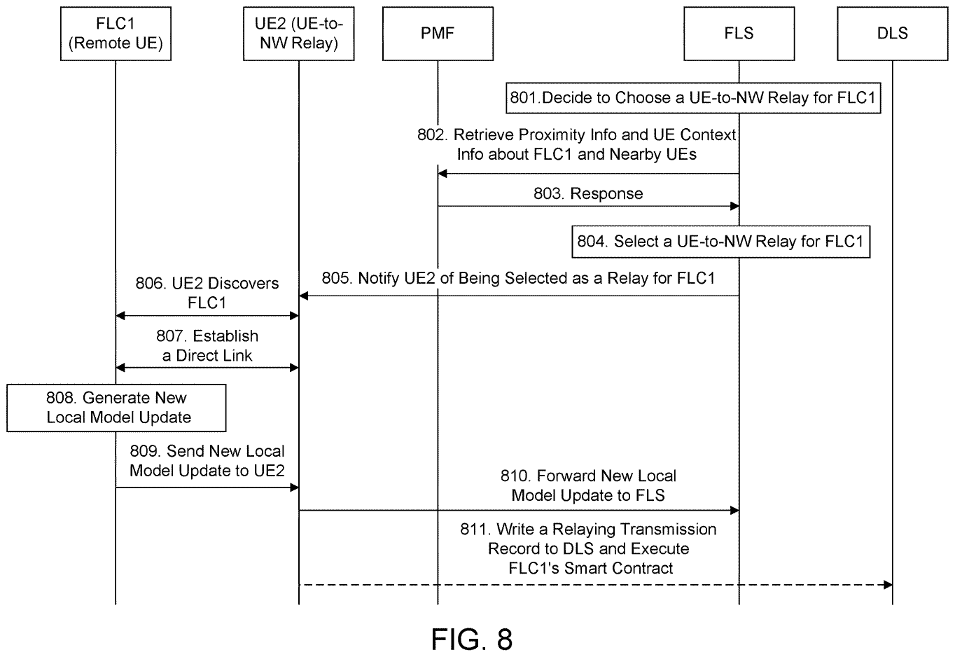

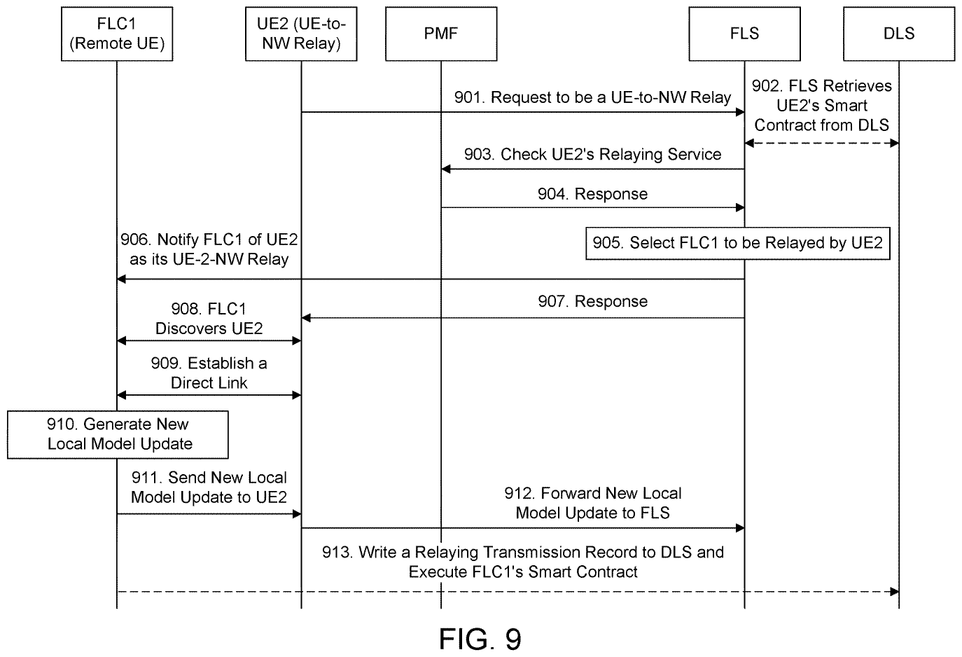

Based on the architecture illustrated in the example of FIG. 6, three methods and detailed procedures for proximity-aware FL training process are illustrated, respectively, in FIG. 7, FIG. 8 and FIG. 9, discussed below. It is noted that, according to certain embodiments, it is contemplated that one or more of the steps or procedures illustrated in FIGS. 7-9 may be combined with each other in any appropriate manner.

FIG. 7 illustrates an example signaling diagram of a procedure for FLC-initiated proximity-aware FL training process, according to various embodiments. It is also noted that FIG. 7 is provided as one example of a method or procedure according to some embodiments, and that various modifications or changes may be made while remaining within the scope of example embodiments of the present disclosure. For example, one or more of the steps or procedures depicted in the example of FIG. 7 may be performed in a different order from that which is illustrated, may be omitted, and/or may be combined with one or more steps or procedures discussed elsewhere herein. Additionally, it should be understood that the nodes or elements depicted being involved in the procedure of FIG. 7 are provided as examples and it should be understood that these nodes may be replaced by other nodes or may be referred to by a different name. For example, as introduced above, the PMF may alternatively be a ProSe Function, a 5G DDNMF, a PCF, an AMF, another existing network function, a new network function, and/or a combination of those functions.

In the scenario illustrated in the example of FIG. 7, during the FL training process, an FLC1 may lose the connectivity to the FLS or does not have sufficient uplink communication capacity to transmit the local model update to the FLS. Another UE (UE2) in the proximity of FLC1 could be selected as a UE-to-NW relay for FLC1. Then, FLC1 can continue to train the local model and can send the local model update to UE2; UE2 may forward FLC1's local model update to the FLS. It is noted that, for the scenario where the FLS is hosted at a UE, UE2 in FIG. 7 will be a UE-to-UE relay, but the same procedure in FIG. 7 can apply. Steps 701 to 711 in FIG. 7 may also be performed before a FL task is executed; in other words, steps 701-711 of FIG. 7 can be used to determine the relay UE before the FL task is executed at each FLC.

In the example of FIG. 7, FLC1 may have an FL task installed, as denoted by a FL-Task-ID. FLC1 may be currently training an AI model for the FL task. However, for example, FLC1 may sense that its uplink has a degraded communication quality and, as shown at 701, it may determine that it needs a relaying FLC (e.g., the UE that hosts FLC1 moves to a new location further away from the base station and starts to have a high packet loss rate in the uplink); in another example, FLC1 may just want to reduce energy consumption in uploading its local model update to the FLS. As a result, FLC1 may decide to request another FLC and/or UE as a UE-to-NW relay (referred to as a relaying FLC) to relay FLC1's local model update to the FLS that installed the FL task.

As further illustrated in the example of FIG. 7, at 702, FLC1 may send a request for a relaying FLC to the FLS. In some example embodiments, this request may contain or indicate one or more of the following parameters: the identifier of the FL task, the identifier of FLC1, the identifiers of nearby UEs/FLCs if FLC1 has performed direct device discovery and discovered those nearby UEs/FLCs already (e.g., then, the FLS can choose one UE/FLC from this list as the relaying UE/FLC for FLC1), and/or the identifier of the group head FLC if FLC1 belongs to a group. It is noted that, in certain embodiments, the request at 702 could be piggybacked or combined with a message in which FLC1 sends its local model update to the FLS.

According to an embodiment, if FLC1 completely loses the connectivity with the network and cannot send a request to the FLS, FLC1 may simply perform step 708 discussed below in order to select a UE-to-NW for itself. As a result, in this case, steps 703 to 707 may be skipped.

As illustrated at 703, the FLS may contact the PMF to retrieve proximity information and UE context for FLC1 and other nearby UEs included in the request at 702. For example, the FLS may retrieve the current location of FLC1 and each of its nearby UE.

In the example of FIG. 7, at 704, the PMF may send a response to the FLS containing the proximity and UE context information of FLC1 and its nearby UEs. Based on the proximity and UE context information, at 705, the FLS may select one or multiple UEs from the list of FLC1's nearby UEs as its relaying UE. If the request received at 702 does not contain any nearby UE, the FLS will find one or multiple nearby UEs from the PMF for FLC1 via step 703 by presenting FLC1's identifier to the PMF. It is noted that, according to some embodiments, if FLC1 presented the group identifier to the FLS, the FLS may simply select one or more group members (i.e., other UEs in the proximity of FLC1) as the relaying UEs for FLC1.

As shown in the example of FIG. 7, at 706, the FLS may send a response to FLC1. The response may contain or indicate a list of relaying UEs as selected by the FLS at 705. In some embodiments, this response may contain or indicate one or more of the following information: the identifier of the FLS, the identifier of the FL task running at the FLC1, the list of identifiers of the selected relaying UEs/FLCs (e.g., UE2), and/or the discovery mode for FLC1 and UE2 to discover each other. For instance, the discovery mode could be model A (i.e., announcement and monitoring) or model B (solicitation and response) as defined in 3GPP TS 23.304 V17.4.0 (2022-09) [6].

In an embodiment, at 707, the FLS may send a notification to UE2 (a UE-to-NW relay selected by the FLS in step 705) to inform that it has been selected as the UE-to-NW relay for FLC1. It is noted that this step is optional. This notification may contain or indicate one or more of the following parameters: the identifier of the FLS, the identifier of FLC1, the identifier of the FL task running at the FLC1, other context information about FLC1 (e.g., its location), and/or the discovery mode for FLC1 and UE2 to discover each other. The discovery mode could be mode A (i.e., announcement and monitoring) or model B (solicitation and response) as defined in 3GPP TS 23.304 V17.4.0 (2022-09) [6].

In the example of FIG. 7, FLC1 may keep a local list of nearby UEs. It also can receive a list of selected relaying UES from the FLS. Then, at 708, FLC1 can select one or multiple relaying UEs from the list of nearby UEs and/or the list of relaying UEs from the FLS. Even if FLC1 still has a connectivity to the network and can reach the FLS, steps 702-707 may be skipped by FLC1 and the FLS; as a result, FLC1 just selects one or multiple relaying UEs from the local list of nearby UEs, which FLC1 has maintained. In the following steps, for purposes of illustration, it may be assumed that UE2 is one of the relaying UE selected by FLC1.

As illustrated in the example of FIG. 7, at 709, FLC1 and UE2 may discover each other, which may be conducted according to the designed discovery mode included in step 706 or 707. If steps 706-707 have not been taken place, FLC1 can use discovery model B to actively solicit and discover UE2.

If FLC1 uses discovery model B, then the following procedures may occur. FLC1 broadcasts a relaying solicitation request to be received by nearby UEs. This solicitation request may contain or indicate the identifier of UE2, the identifier of FLC1, the identifier of the FL task, the address of FLC1's smart contract as stored in the Distributed Ledger System (DLS). UE2 may receive the solicitation request and realizes that it has been requested to be the UE-to-NW relay for FLC1. UE2 may retrieve FLC1's smart contract from the DLS. UE2 may reject FLC1's request based on the FL task (e.g., reject the request if the AI model trained by the FL task is of a large size), the content of FLC1's smart contract (e.g., reject the request if FLC1's smart contract does not describe or provide enough incentive), etc. If UE2 agrees, it may send a solicitation response to FLC1 indicating its willingness to be FLC1's UE-to-NW relay.

If step 707 has taken place, then UE2 may use the following procedure to make itself be discovered by FLC1. UE2 may broadcast an announcement message indicating its availability to be a UE-to-NW relay, which may contain the identifier of UE2, the identifier of the FL task, the address of UE2's smart contract as stored in the DLS. FLC1 may monitor and receive the announcement message. If FLC1 agrees (e.g., FLC1 is able to afford the relay service agreement as described in UE2's smart contract), FLC1 may just select UE2 as its UE-to-NE relay.

In the example of FIG. 7, at 710, FLC1 may send a direct communication request to UE2. This request may contain or indicate any one or more of: FLC1's smart contract address, the identifier of the FL task, the expected size of the local model update, the expected frequency of sending the local model update to UE2, the identifier of the FLS, the expected time to finish the current local training round, etc. UE2 may authenticate this request; for example, if the expected size of the local model update is too big and/or the expected frequency is too high, then UE2 may reject the direct communication request. UE2 may send a response message to FLC1 indicating if the direct communication request has been authorized or rejected. If UE2 accepts the direct communication request, it may maintain a relaying relationship record associating the identifier of FLC1, the identifier of FL task, the identifier of the FLS, etc. UE2 may send the identifier of the relaying relationship record to FLC1.

In the example of FIG. 7, at 711, UE2 may optionally send a transaction to the DLS to trigger and/or execute FLC1's smart contract since FLC1 and UE2 agreed to establish a direct communication link at 710.

According to an embodiment, if FLC1 selected multiple relaying UEs/FLCs in step 708, steps 709-711 may be repeated for each relaying UE/FLC.

In the example of FIG. 7, at 712, FLC1 may complete the current local training round and may generate new local model update. At 713, FLC1 may send the new local model update, and may include or indicate the identifier of the FL task (and/or the identifier of the relaying relationship record between FLC1 and UE2), to UE2. If FLC1 selected multiple relaying UEs/FLCs in step 708, FLC1 may split the local model update to multiple pieces and may send each piece to a different relaying UE/FLC; each relay FLC will forward each piece to the FLS; the FLS will eventually receive all pieces from those multiple relaying UEs/FLCs; each piece may additionally contain a sequence number so that the FLS can merge those pieces in the right order according to their sequence number to recover the original local model update.

As illustrated in the example of FIG. 7, UE2 may search its local relaying relationship records and find the identifier of the FLS. As shown at 714, UE2 may forward the local model update to the FLS. The FLS may receive FLC1's local model update from UE2; if the local model update were split into multiple pieces and relayed to the FLS through multiple relaying UEs, the FLS can recover the original local model update from those pieces according to the sequence number contained in the piece.

In the example of FIG. 7, at 715, UE2 may optionally generate a relay transmission record and store it to the DLS. This relaying transmission record may contain the identifier of FLC1, the identifier of UE2, the identifier of the FL task, the identifier of the FLS, the full content or the hash value of the local model update sent over at 714, the time when step 714 took place, the size of the local model update, etc.

FIG. 8 illustrates an example signaling diagram of a network node or server-initiated proximity-aware FL training process, according to various embodiments. In some embodiments, the network node or server may be a FLS or an application server, for example. In the example of FIG. 8, the network node or server is depicted as an FLS; however, it should be understood that this is provided as one example and that other types of nodes or servers may also be used. Similarly, although a PMF is illustrated in the example of FIG. 8, the PMF may be replaced by other core network nodes or network functions, as described elsewhere herein. Thus, it should be understood that the network nodes or elements depicted in the FIGS. are provided as one example and that other types of nodes or servers may also be used while remaining within the scope of example embodiments.

It is also noted that FIG. 8 is provided as one example of a method or procedure according to some embodiments, and that various modifications or changes may be made while remaining within the scope of example embodiments of the present disclosure. For example, one or more of the steps or procedures depicted in the example of FIG. 8 may be performed in a different order from that which is illustrated, may be omitted, and/or may be combined with one or more steps or procedures discussed elsewhere herein (e.g., may be combined with or modified by one or more elements of FIG. 7).

In some cases, as depicted in the example of FIG. 8, FLC1 may completely lose connectivity with the network or the quality of its uplink to the FLS may become degraded (e.g., significantly degraded). As a result, the FLS may not receive any message directly from FLC1 for a long time and/or the FLS cannot directly reach FLC1. Also, the FLS may perceive a long latency in receiving a message from FLC1. For such scenarios, the FLS may actively trigger to select a UE-to-NW relay for FLC1. Steps 801 to 807 in FIG. 8 may also be performed before a FL task is executed; in other words, steps 801-807 of FIG. 8 can be used to determine the relay UE before the FL task is executed at eachFLC.

For the scenario where the FLS is hosted at a UE, UE2 in FIG. 8 will be a UE-to-UE relay, but the same procedure as in FIG. 8 can apply.

As illustrated in the example of FIG. 8, at 801, the FLS may decide to choose a UE-to-NW relay for FLC1. Conditions for the FLS to decide to select a relay may include one or more of: (1) if the FLS does not receive any message (e.g., a short heartbeat or keepalive message) from FLC after a configured time period, and/or (2) if the FLS receives a local model update from FLC1 after a configured time period or window.

In the example of FIG. 8, at 802, The FLS may contact the PMF to retrieve proximity information and UE context for FLC1. For example, the FLS may retrieve the current location of FLC1 and any nearby UEs that support UE-to-NW relay services. For this purpose, in an embodiment, the FLS may send to the PMF a request containing or indicating a list of parameters including the identifier of FLC1, the identifier of the UE hosting FLC1, and/or the request purpose (e.g., to retrieve nearby UEs that support UE-to-NW relay services).

As illustrated at 803, the PMF may send a response to the FLS. This response may contain or indicate the proximity and/or UE context information of FLC1 (e.g., its current location, its uplink quality, etc.) and/or a list of its nearby UEs that supports UE-to-NW relay services. Those nearby UEs may be selected as a UE-to-NW relay for FLC1.

Based on the proximity and UE context information, in the example of FIG. 8 at 804, the FLS may select one or multiple UEs from the list of FLC1's nearby UEs as its UE-to-NW relay. If step 803 does not contain a list of nearby UEs, the FLS may select another existing FLC (e.g., FLC2) as the UE-to-NW relay for FLC1, for example, according to the location of FLC1 and/or FLC2, and/or the services provided by FLC2. In this example, for purposes of illustration, it may be assumed that UE2 be the selected UE-to-NW relay for FLC1.

As shown in the example of FIG. 8, at 805, the FLS may send a notification to UE2 (a UE-to-NW relay selected by the FLS in step 4) to inform that it has been selected as the UE-to-NW relay for FLC1. This notification may contain one or more of the following parameters: the identifier of the FLS, the identifier of FLC1, the address of FLC1's smart contract, a relay service token that the FLS generates for UE2 and FLC1 (e.g., UE2 may present this relay service token to FLC1 in step 807 for authentication and authorization purposes. This token may be generated according to a relay service token generation algorithm (e.g., a hash function) using inputs such as the identifier of FLS, the identifier of FLC1, and/or the identifier of the FL task. The FLS may have configured the relay service token generation algorithm to and made it known to all existing FLCs), the identifier of the FL task running at the FLC1, other context information about FLC1 (e.g., its location), and/or the discovery mode UE2 to discover FLC1 (e.g., the discovery mode could be model A (i.e., announcement and monitoring) or model B (solicitation and response) as defined in 3GPP TS 23.304 V17.4.0 (2022-09) [6]).

In an embodiment, UE2 may retrieve FLC1's smart contract from the Distributed Ledger System (DLS). Based on the smart contract content, UE2 may reject to be the UE-2-NW relay for FLC1 (e.g., if FLC1's smart contract does not describe or provide enough incentive). If UE2 agrees to be a relaying UE for FLC1, as shown at 806, UE2 may need to discover FLC1 or be discovered by FLC1, which may be conducted according to the designated discovery models included in step 705.

According to some embodiments, UE2 may use the discovery model A to make itself discoverable by FLC1 with the following procedure. In this case, UE2 may broadcast an announcement message indicating its availability to be a UE-to-NW relay, which may contain or indicate the identifier of UE2, the identifier of the FL task, and/or the address of UE2's smart contract as stored in the DLS. FLC1 may monitor and/or receive the announcement message. If FLC1 agrees, FLC1 may just select UE2 as its UE-to-NW relay.

In certain embodiments, UE2 may use discovery model B to actively solicit FLC1. In this case, UE2 may broadcast a solicitation request to be received by nearby UEs. This solicitation request may contain or indicate the identifier of the FLS, the identifier of UE2, the identifier of FLC1, the identifier of the FL task, and/or the address of UE2's smart contract as stored in the DLS. FLC1 may receive the solicitation request and realize that UE2 has been selected as its UE-to-NW relay. FLC1 may authenticate the request (e.g., based on the identifier of the FLS or based on the relay service token that UE2 may include in the solicitation request using the similar process as described below) and send a response to UE2 as a confirmation.

According to some embodiments, UE2 may send a direct communication request to FLC1. This request may contain the relay service token as received in step 705. FLC1 may receive the direct communication request and may authenticate it. For example, FLC1 may use the relay service token generation algorithm as configured by the FLS to generate a temporary relay service token and compare the temporary relay service token with the relay service token received from UE2. If both tokens are identical, the direct communication request is approved. Then, FLC1 may send a response to UE2 indicating if it approves or rejects the direct communication request from UE2. Assuming FLC1 approves the direct communication request, then a direct link will be established between UE2 and FLC1, as shown at 807 in the example of FIG. 8. If FLC1 approves the direct communication request, it will maintain a relaying relationship record associating the identifier of UE2, the identifier of FL task, the identifier of the FLS, etc. UE2 may also maintain a relaying relationship record associating the identifier of FLC1, the identifier of FL task, the identifier of the FLS, etc. UE2 may send the identifier of the relaying relationship record to FLC1.

As illustrated in the example of FIG. 8, at 808, FLC1 may complete the current local training round and generate a new local model update. In some embodiments, this step 808 may occur before step 806.

As illustrated at 809, FLC1 may send a message containing or indicating the new local model update to UE2. This message may also contain or indicate additional parameters such as, but not limited to, the identifier of the FL task, the identifier of the FLS, the identifier of the relaying relationship record, etc.

In the example of FIG. 8, UE2 may search its local relaying relationship records to find the identifier of the FLS, if it is not contained in step 809. As shown at 810, UE2 may forward the local model update to the FLS. Therefore, the FLS may receive FLC1's local model update from UE2.

According to some embodiments, as illustrated at 811, UE2 may optionally generate a relaying transmission record and store it to the DLS. This relaying transmission record may contain the identifier of FLC1, the identifier of UE2, the identifier of the FL task, the identifier of the FLS, the full content or the hash value of the local model update sent over in step 810, the time when step 810 took place, the size of the local model update, etc. UE2 may use the same transaction (or send a new transaction) to trigger and/or execute FLC1's smart contract to collect credits from FLC1 for the relay services that UE2 has provided in step 10. This transaction may be validated by the FLS via the DLS.

FIG. 9 illustrates an example signaling diagram for a relay-initiated proximity-aware FL training process, according to various embodiments. It is noted that FIG. 9 is provided as one example of a method or procedure according to some embodiments, and that various modifications or changes may be made while remaining within the scope of example embodiments of the present disclosure. For example, one or more of the steps or procedures depicted in the example of FIG. 9 may be performed in a different order from that which is illustrated, may be omitted, and/or may be combined with one or more steps or procedures discussed elsewhere herein (e.g., may be combined with or modified by one or more elements of FIGS. 7 and/or 8).

In the example scenario depicted in FIG. 9, a UE (e.g., a parked vehicle) may have sufficient resources to support UE-to-NW relay services. As such, it may actively send a request to the FLS indicating its willingness to be a UE-to-NW relay for one or multiple FLCs. In the example of FIG. 9, UE2 may support UE-to-NW relay services. It may be assumed that UE2 knows the address of the FLS; for example, UE2 could be an existing FLC or UE2 may discover the FLS from other entities (e.g., a distributed ledger system, a service layer server, an application repository function that may be deployed in future 6G system, etc.). Steps 901 to 909 in FIG. 9 may also be performed before a FL task is executed; in other words, steps 901-909 of FIG. 9 can be used to determine the relay UE before the FL task is executed at each FLC.

For the scenario where the FLS is hosted at a UE, UE2 in FIG. 9 will be a UE-to-UE relay, but the same procedure shown in FIG. 9 may apply.

As illustrated in the example of FIG. 9, at 901, UE2 may send a request to the FLS indicating its willingness to be a UE-2-NW relay for one or multiple FLCs. This request may contain or indicate one or more of the following parameters: the identifier of the PMF, the identifier of UE2, the identifier of an existing FL task, the identifier of a list of existing FLCs that UE2 would like to provide UE-to-NW relay services to (this parameter may be optional), and/or the address of UE2's smart contract.

As shown at 902, the FLS may receive the request and may retrieve UE2's smart contract from the Distributed Ledger System (DLS) and authenticate and/or approve the request, e.g., based on the smart contract. For example, if the smart contract describes too stringent relay service conditions (e.g., only available for a specific time period and/or at a specific location, request to collect more credits for the relay services to be provided), the FLS may reject the request and steps 902-906 may be skipped. In this case, the FLS may send a response with a rejection to UE2 in step 907.

In the example of FIG. 9, at 903, the FLS may contact the PMF to check the following information: if UE2 has already been authorized to provide UE-to-NW relay services, and/or the context information about UE2 such as its current location, anticipated mobility trajectory, etc. At 904, the PMF may send a response to the FLS. The response may contain or indicate the information that the FLS has requested in step 903.

If the PMF informed in step 904 that UE2 cannot provide UE-to-NW relay services, the FLS may reject UE2's request and may send a rejection in step 907 to UE2. Otherwise, as shown at 905, the FLS may select one or multiple existing FLCs, which can potentially be relayed by UE2. The FLS may make the selection based on information such as the location of UE2, the location of existing FLCs, the smart contact content of UE2 and/or existing FLCs, etc. In the example of FIG. 9, it may be assumed that FLC1 is selected at 905.

In the example of FIG. 9, at 906, the FLS may send a notification to FLC1 to inform that FLC1 should start to discover and use UE2 as a UE-to-NW relay for relaying FLC1's local model update to the FLS. This notification may contain or indicate one or more of the following parameters: the identifier of the FLS, the identifier of UE2, the address of UE2's smart contract, a relay service token that the FLS generates for UE2 and FLC1 (e.g., FLC1 may present this relay service token to UE2 in step 909 for authentication and authorization purposes. This token may be generated according to a relay service token generation algorithm (e.g., a hash function) using inputs such as the identifier of FLS, the identifier of UE2, and/or the identifier of the FL task. The FLS may configure this relay service token generation algorithm to UE2 in step 907), other context information about UE2 (e.g., its location), and/or the discovery mode for FLC1 to discover UE2 (e.g., the discovery mode could be model A (i.e., announcement and monitoring) or model B (solicitation and response) as defined in 3GPP TS 23.304 V17.4.0 (2022-09) [6]). It is noted that 906 may occur before 907.

In the example of FIG. 9, at 907, the FLS may send a response to UE2 indicating if the request in step 901 is approved or rejected. If the request in step 901 is approved, this response may contain or indicate one or more of the following information: the identifier of the FLS, the identifier of FLC1, the address of FLC1's smart contract, the relay service token generation algorithm used as a part of step 906, the identifier of the FL task, other context information about FLC1 (e.g., its location), and/or the discovery mode for FLC1 to discover UE2 (e.g., the discovery mode could be model A (i.e., announcement and monitoring) or model B (solicitation and response) as defined in 3GPP TS 23.304 V17.4.0 (2022-09) [6]).

As illustrated in the example of FIG. 9, FLC1 may retrieve UE2's smart contract from the DLS. Based on the smart contract content, FLC1 may reject or approve UE2. If FLC1 agrees to use UE2 as its relaying UE, at 908, FLC1 may need to discover UE2 or be discovered by UE2, which may be conducted according to the designed discovery models included in step 905.

In some embodiments, FLC1 may use the discovery model A to make itself be discovered by UE2 according to the following procedure. FLC1 may broadcast an announcement message indicating its interest in using a UE-to-NW relay, which may contain or indicate the identifier of FLC1, the identifier of the FL task, and/or the address of FLC1's smart contract as stored in the DLS. UE2 may monitor and/or receive the announcement message. If this FLC identifier contained in the announcement message is the same as the one in step 907, UE2 may simply select FLC1 for providing its UE-to-NW relay services to.

According to some embodiments, FLC1 may use discovery model B to actively solicit UE2. In this case, FLC1 may broadcast a solicitation request to be received by nearby UEs. This solicitation request may contain or indicate the identifier of the FLS, the identifier of UE2, the identifier of FLC1, the identifier of the FL task, and/or the address of FLC1's smart contract as stored in the DLS. UE2 may receive the solicitation request and may realize that FLC1 has been selected as the FLC to use UE2's UE-to-NW relay services. UE2 may authenticate the request (e.g., based on the identifier of the FLS, or based on the relay service token that FLC1 may include in the solicitation request using the similar process described below) and may send a response to FLC1 as a confirmation.

In the example of FIG. 9, FLC1 may send a direct communication request to UE2. This request may contain the relay service token as received in step 906. UE2 may receive the direct communication request and may authenticate it. For example, UE2 may use the relay service token generation algorithm as configured by the FLS in step 907 to generate a temporary relay service token and compare the temporary relay service token with the relay service token received from the FLC1. If both tokens are identical, the direct communication request may be approved. Then, UE2 may send a response to FLClindicating if it approves or rejects the direct communication request from FLC1. If UE2 approves the direct communication request, at 909, a direct link may be established between UE2 and FLC1. UE2 may maintain a relaying relationship record associating the identifier of FLC1, the identifier of FL task, and/or the identifier of the FLS, etc. FLC1 may also maintain a relaying relationship record associating the identifier of UE2, the identifier of FL task, and/or the identifier of the FLS, etc.

As illustrated in the example of FIG. 9, at 910, FLC1 may complete the current local training round and generate new local model update. In some embodiments, this step 910 may occur before step 908. At 911, FLC1 may send a message containing the new local model update to UE2. This message may also contain or indicate additional parameters such as, but not limited to, the identifier of the FL task, the identifier of the FLS, the identifier of the relaying relationship record between FLC1 and UE2, etc.

In the example of FIG. 9, UE2 may search its local relaying relationship records and find the identifier of the FLS if it is not contained in step 911. At 912, UE2 may forward the local model update to the FLS. Thus, the FLS may receive FLC1's local model update from UE2.

According to some embodiments, as shown at 913, UE2 may generate a relaying transmission record and store it to the DLS. This relaying transmission record may contain the identifier of FLC1, the identifier of UE2, the identifier of the FL task, the identifier of the FLS, the full content or the hash value of the local model update sent over in step 912, the time when step 910 took place, the size of the local model update, etc. UE2 may use the same transaction (or send a new transaction) to trigger/execute FLC1's smart contract to collect credits from FLC1 for the relay services that UE2 has provided in step 912. This transaction may be validated by the FLS via the DLS.

Various embodiments described herein may provide enhancements to 3GPP ProSe services.

For example, an embodiment may provide for direct discovery configuration and coordination by 5G DDNMF.

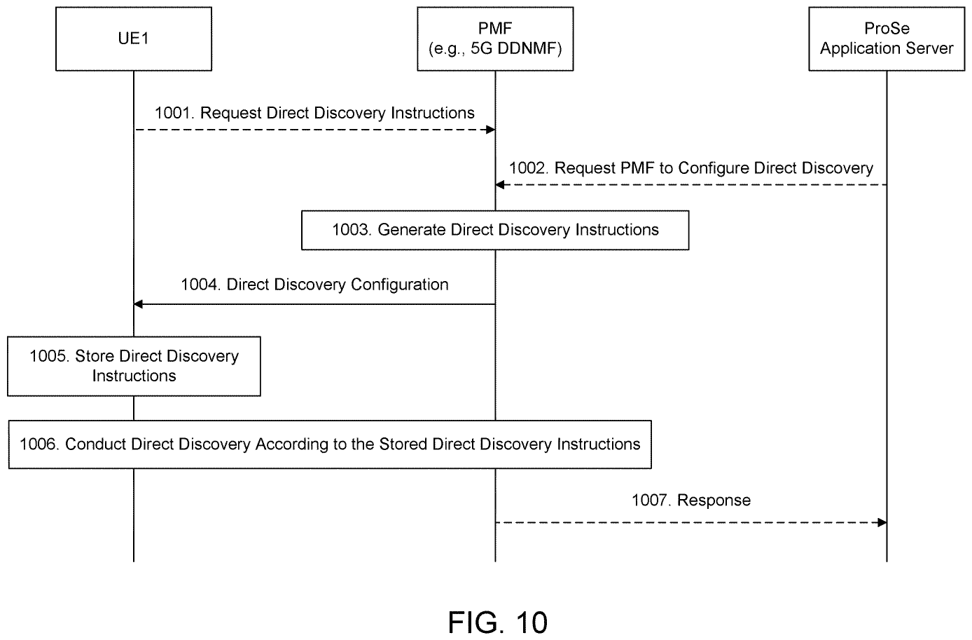

FIG. 10 illustrates an example procedure for direct discovery configuration as an enhancement to 3GPP ProSe Services, according to some embodiments. In this embodiment, a PMF (i.e., 5G DDNMF) may configure UE1 with some direct discovery instructions so that: (1) UE1 can be effectively discovered by another UE2, and/or (2) UE1 can effectively discover another UE2. Configured direct discovery instructions could lead to a smaller number of resulting messages during direct discovery and make direct discovery more energy-efficient or communication-efficient.

In the example of FIG. 10, at 1001, UE1 may optionally send a request to the PMF to obtain some direct discovery instructions. This request may contain or indicate one or more of the following parameters: the identifier of UE1, the identifier of UE2 (e.g., if UE1 knows UE2), the identifier of ProSe Application Server, the location of UE1, the ProSe Application Code/ProSe Restricted Code (e.g., which UE1 may have previously obtained from the PMF), and/or other context information about UE1 (e.g., battery level). It is noted that step 1001, may be integrated into “the procedure of service authorisation for 5G ProSe direct discovery services” as defined in 3GPP TS 23.304 V17.4.0 (2022-09) [6].

In the example of FIG. 10, at 1002, a ProSe Application Server may optionally request the PMF to configure direct discovery instructions to some UEs (e.g., UE1 and UE2). This request may contain or indicate one or more of the following parameters: the identifier of UE1, the identifier of UE2, and/or the identifier of the ProSe Application Server.

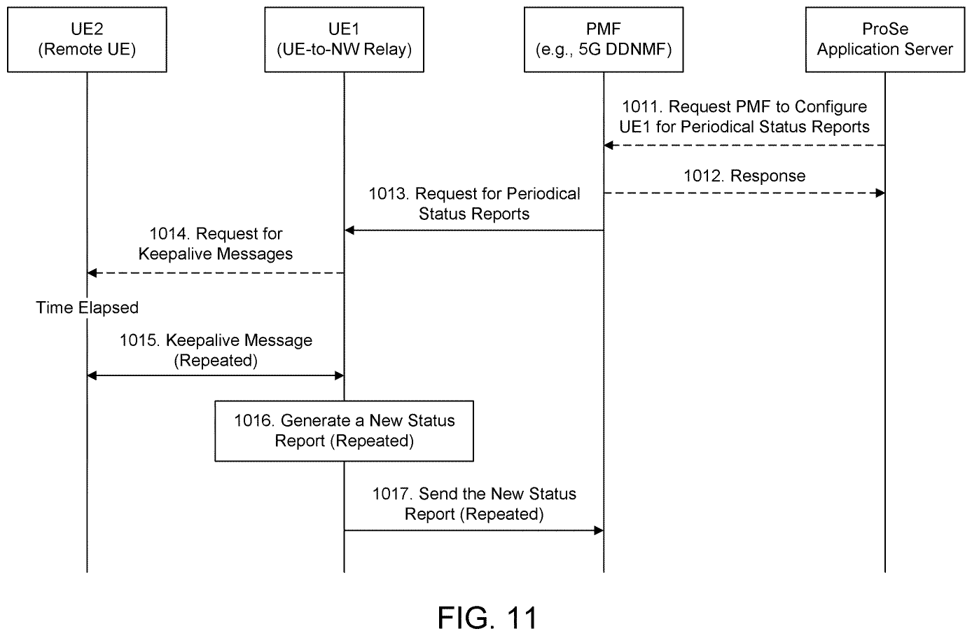

As shown in the example of FIG. 10, at 1003, the PMF may generate and determine direct discovery instructions for UE1 and/or UE2. For this purpose, the PMF may first retrieve UE1's context information (e.g., 5G ProSe Capability and 5G Authorized Info) from its AMF or PCF, based on which the PMF my determine appropriate direct discovery instructions. The PMF may make the decision to execute step 1003 based on status reports from other UEs via the procedure in FIG. 11 discussed below. Examples of direct discovery instructions include, but are not limited to, one or more of the following: Direct Discovery Instruction #1 (e.g., UE1 shall use Model B to discover UE2, i.e., UE1 sends a solicitation message to UE2 and UE2 sends a response to UE1), Direct Discovery Instruction #2 (e.g., UE1 shall use Model A to discover UE2, i.e., UE1 monitors announcement message to be sent from UE2), Direct Discovery Instruction #3 (e.g., UE1 shall use Model B to be discovered by UE2, i.e., UE1 waits to receive a solicitation message from UE2 and replies back with a response message to UE2), Direct Discovery Instruction #4 (e.g., UE1 shall use Model A to be discovered by other UEs (e.g., UE1 announces itself while UE2 monitors UE1's announcement) and UE1 shall send an announcement message every a time internal T1 or shall not send more than one announcement message every a time internal T2), Direct Discovery Instruction #5 (e.g., to apply Direct Discovery Instruction #1 in a physical region A), Direct Discovery Instruction #6 (e.g., to apply Direct Discovery Instruction #2 in a physical region B), and/or Direct Discovery Instruction #7 (e.g., to apply Direct Discovery Instruction #3 and/or #4 when UE1's battery level is below a threshold (e.g., below 50%) to save energy).

In some embodiments, each Direct Discovery Instruction j (DDI-j) may contain or indicate one or more of the following common parameters:
The unique identifier of DDI-j;
The identifier of the UE as discoverer;
The identifier of the UE as discoveree;
The discovery mode (e.g., open ProSe direct discovery mode A, open ProSe direct discovery mode B, restricted ProSe direct discovery mode A, restricted ProSe direct discovery mode B) that the discoverer shall use to discover the discoveree;
Direct-Discovery-Condition: It may indicate a physical region that DDI-j can only be executed when UE1 (and/or UE2) is within this physical region. Through this parameter, DDI-j can also indicate that different discovery mode, different discoverers, and different discoveree should be applied to different physical regions; and/or
Time-for-Next-Direct-Discovery: Indicates the time when the UE1 (and/or UE2) should start direct discovery according to the direct discovery instruction; or indicate the waiting time that UE1 (and/or UE2) should wait for after receiving the message from step 1004 and before performing direct discovery in step 1006.

In the example of FIG. 10, at 1004, the PMF may send the determined direct discovery instructions to UE1. This direct discovery configuration message may contain or indicate one or more of the following parameters: the direct discovery instructions determined for UE1 in step 1003; the identifier of UE2 which is to be discovered by UE1 or which will discover UE1; the identifier of the ProSe Application Server; the ProSe Application Code/ProSe Restricted Code; and/or the expiration time of each direct discovery instruction. The PMF may use a procedure similar to step 1004 to send direct discovery instructions to UE2. At 1005, UE1 may store the direct discovery instructions received from step 1004.

As further illustrated in the example of FIG. 10, according to the direct discovery instructions received from step 1004, UE1 may check if “Direct-Discovery-Condition” as contained in the direct discovery instruction has been satisfied; for example, if it has been satisfied and the waiting time as indicated by “Time-for-Next-Direct-Discovery” is zero, UE1 may, as shown at 1006, conduct corresponding direct discovery procedure as defined in 3GPP TS 23.304 V17.4.0 (2022-09) [6]. For example, if the direct discovery instruction indicates a battery level threshold, UE1 may actively use mode A or B (when the battery level is above the threshold) to discover another UE; otherwise, UE1 may passively use mode A or B (when the battery level is below the threshold) to wait to be discovered by another UE. In another example, UE1 and UE2 may wait for a time interval as indicated by “Time-for-Next-Direct-Discovery” (e.g., UE1 and UE2 switch to a power-saving or sleeping mode); after that, UE1 (or UE2) may start to send a discovery announcement message while UE2 (or UE1) may start to monitor discovery accouncement message. In another example, UE1 and UE2 may wait for a time interval as indicated by “Time-for-Next-Direct-Discovery” (e.g., UE1 and UE2 switch to a power-saving or sleeping mode); after that, UE1 (or UE2) may start to send a discovery solicitation request while UE2 (or UE1) may start to receive the discovery solicitation request from UE1 (or UE2) and prepare a discovery response message and send the response message to UE1 (or UE2).

In an embodiment, at 1007, the PMF may optionally send a response to the ProSe Application Server if step 1002 occurred. This response may indicate the direct discovery configuration as requested in step 1002 was completed and that corresponding UEs (e.g., UE1 and UE2) have discovered each other (or have failed to discover each other).

An embodiment may enhance ProSe services by providing periodical status report(s) to 5G DDNMF. For instance, FIG. 11 illustrates an example of a procedure for a PMF to configure how UE1 (e.g., as a UE-to-NW relay) and UE2 (e.g., as a remote UE) should generate periodical status reports from UE1 to a PMF (e.g., 5G DDNMF) and/or generate keepalive messages between UE1 and UE2. The provided procedure may be important for the training process of federated learning, since the training process may take a long time to complete and knowing the status of the relay UE and the remote UE can be useful, e.g., to determine if an existing FLC is still reachable, if a new UE-to-NW needs to be selected, etc.

As illustrated in the example of FIG. 11, at 1011, the ProSe Application Server may optionally send a request to the PMF asking to configure UE1 for periodical reports. This request may contain or indicate one or more of the following parameters:
The identifier of the ProSe Application Server;
The identifier of UE1;
The identifier of remote UEs (e.g., UE2);
The time period Tp. After each Tp, the UE1 shall send a status report to the PMF; then the report will be forwarded by the PMF to the ProSe Application Server; and/or
The list of parameters whose values may be included in each periodical status report, such as: the identifier of UE1; the location of UE1; the number of remote UEs that UE1 has a direct link with; if the direct link between UE1 and each remote UE (e.g., UE2) is still alive; the time when UE1 and each remote UE (e.g., UE2) exchanged the last keepalive message; and/or the identifier of each remote UE (e.g., UE2).

In the example of FIG. 11, at 1012, the PMF may process the request from step 1011 and may send a response to the ProSe Application Server. If step 1011 is skipped, then step 1012 may also be skipped.

As shown in the example of FIG. 11, at 1013, the PMF may send a request to UE1 to configure some parameters to UE1, based on which: (1) UE1 will send periodical status report to the PMF, and/or (2) UE1 will exchange keepalive message with each remote UE (e.g., UE2). These parameters may come from step 1011 or may be determined by the PMF. The parameters may include one or more of:
The ProSe Application Code/ProSe Restricted Code;
The identifier of UE1;
The identifier of remote UE (e.g., UE2);
The time period Tp1. After each Tp1, UE1 shall send a status report to the PMF. Tp1 may be equal to Tp from step 1011;
The time period Tp2. After each Tp2, UE1 and a remote UE (e.g., UE2) should exchange two keepalive messages (e.g., one from UE1 to UE2 and the other from UE2 to UE1). Tp2 may be much less than Tp1; and/or
The list of parameters whose values may be included in each periodical status report, such as: the identifier of UE1; the location of UE1; the number of remote UEs that UE1 has a direct link with; if the direct link between UE1 and each remote UE (e.g., UE2) is still alive; the time when UE1 and each remote UE (e.g., UE2) exchanged the last keepalive message; and/or the identifier of each remote UE (e.g., UE2).

In the example of FIG. 11, UE1 may receive the request from step 1013, based on which UE1 may optionally send, as shown at 1014, a new request to UE2 to configure needed parameters for UE2 and UE1 to exchange keepalive messages. This new request to UE2 may contain or indicate one or more of the following parameters:
The ProSe Application Code/ProSe Restricted Code;
The identifier of UE1;
The time period Tp2. After each Tp2, UE2 and UE1 should exchange keepalive messages; and/or
The list of parameters whose values may be included in a keepalive message from UE2 to UE1, such as: the identifier of UE2; the location of UE2; and/or the ProSe Application Code/ProSe Restricted Code.

As illustrated in the example of FIG. 11, UE2 may receive the request in step 1014 from UE1. It starts to prepare sending a keepalive message to UE1. As shown at 1015, after certain time (e.g., Tp2) elapsed, UE2 may send a keepalive message to UE1; then UE1 may send back a keepalive message to UE2. If step 1014 is skipped, UE1 may actively send a keepalive message to UE2 every Tp2; then UE2 sends back a keepalive message to UE1, which may contain the identifier of UE1, the location of UE1, and/or the ProSe Application Code/ProSe Restricted Code.

In the example of FIG. 11, at 1016, e.g., every Tp1, UE1 may generate a new status report based on the keepalive message exchanged with each remote UE (e.g., UE2). The new status report may contain or indicate one or more of the following parameters: the ProSe Application Code/ProSe Restricted Code; the identifier of UE1; the location of UE1; the number of remote UEs that UE1 has a direct link with; the number of keepalive messages that UE1 has successfully exchanged with each remote UE (e.g., UE12) during Tp1; the time when UE1 and each remote UE (e.g., UE2) exchanged the last keepalive message; and/or the identifier of each remote UE (e.g., UE2). At 1017, UE1 may send the new status report to the PMF. The PMF may optionally forward the entire or partial of the new status report to the ProSe Application Server as a notification.

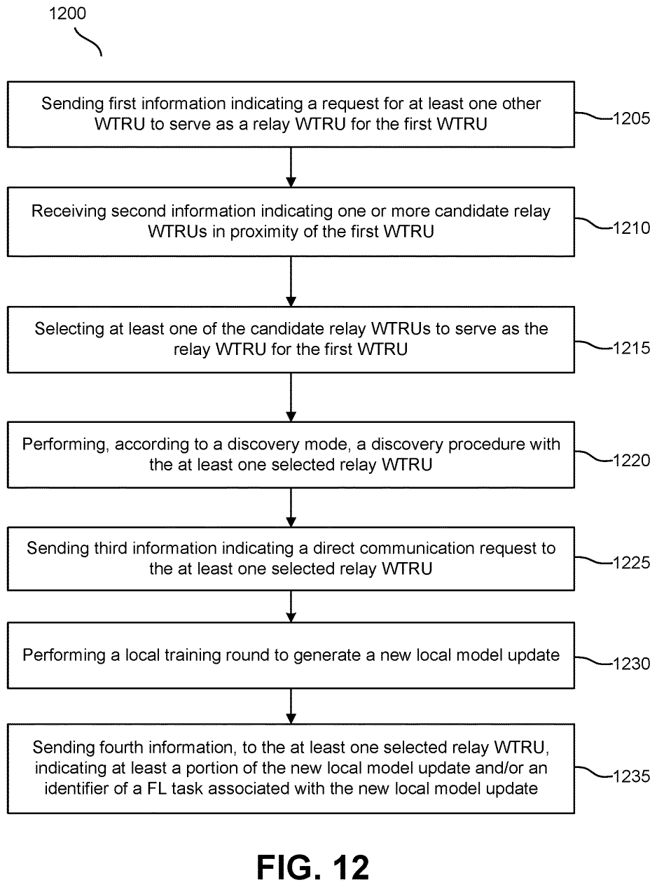

FIG. 12 illustrates an example flow diagram of a method 1200, which may be implemented in a first wireless transmit/receive unit (WTRU). For example, in some embodiments, the method may include any one or more of the steps performed by or associated with FLC1 and/or UE1 as discussed elsewhere herein, such as described in or with respect to FIGS. 7-11. For example, the first WTRU implementing the method 1200 may be or may include a FLC. It should also be understood that one or more of the steps of the method may be optional, may be omitted, and/or may be performed in a different order.

In an embodiment, as illustrated in the example of FIG. 12, the method 1200 may include, at 1205, sending, to a network node, first information indicating a request for at least one other WTRU (e.g., a second WTRU and third WTRU, etc.) to serve as a relay WTRU for the first WTRU. The method 1200 may include, at 1210, receiving, from the network node, second information indicating one or more candidate relay WTRUs in proximity of the first WTRU. Based at least on the second information, the method 1200 may include, at 1215, selecting at least one of the candidate relay WTRUs to serve as the relay WTRU for the first WTRU. The method 1200 may include, at 1220, performing, according to a discovery mode, a discovery procedure with the at least one selected relay WTRU. The method 1200 may include, at 1225, sending third information indicating a direct communication request to the at least one selected relay WTRU. The method 1200 may include, at 1230, performing the current local training round to generate a new local model update. The method 1200 may also include, at 1235, sending fourth information, to the at least one selected relay WTRU, indicating at least a portion of the new local model update and/or an identifier of a FL task associated with the new local model update.

In some examples, the first information may further indicate or include any one or more of: (i) an identifier associated with a federated learning (FL) task, (ii) an identifier associated with the first WTRU, (iii) an identifier associated with each of one or more of the at least one other WTRU that is in proximity of the first WTRU, and/or (iv) an identifier associated with a group head of a group that the first WTRU belongs to.

According to certain embodiments, the second information may further indicate or include any one or more of: (i) an identifier associated with the network node, (ii) an identifier associated with a FL task running at the first WTRU; (iii) an identifier associated with each of the one or more candidate relay WTRUs, and/or (iv) a discovery mode for performing discovery between the first WTRU and one or more of the candidate relay WTRUs.

In some examples, the third information may further indicate or include any one or more of: (i) information indicating a smart contract address associated with the first WTRU, (ii) information indicating the identifier of the FL task, (iii) information indicating an expected size of a local model update, (iv) information indicating an expected frequency of sending the local model update to the at least one selected relay WTRU, (v) information indicating the identifier of the network node, and/or (vi) information indicating an expected time to finish a current local training round.

In an example embodiment, the method 1200 may include receiving information, e.g., from the at least one selected relay WTRU, indicating that the direct communication request has been authorized.

According to an example embodiment, the method 1200 may include determining to send the request for the least one other WTRU to serve as a relay WTRU for the first WTRU based on any one or more of: (i) sensing that the first WTRU's uplink has a degraded communication quality, and/or (ii) a preference to reduce energy consumption in uploading the first WTRU's local model update to the network node.

Various embodiments may be directed to a method, which may be implemented in a network node. For example, in some embodiments, the method may include any one or more of the steps performed by or associated with the FLS as discussed elsewhere herein, such as described in or with respect to FIGS. 7-11. It should also be understood that one or more of the steps of the method may be optional, may be omitted, and/or may be performed in a different order.

In an embodiment, the method may include determining, e.g., by a network element or server (e.g., FLS), to select a user equipment (UE)-to-network (NW) relay for a federated learning client (FLC). The method may include sending, to a network node or function (e.g., PMF or AMF), first information indicating a request for proximity information and context information associated with the FLC. The method may include receiving, from the network node, second information indicating: (i) the proximity information and context information associated with the FLC, and (ii) one or more WTRUs in proximity of the FLC that support UE-to-NW relay services. Based at least on the second information, the method may include selecting at least one of the WTRUs to serve as a UE-to-NW relay for the FLC. The method may include sending, to the at least one of the WTRUs, third information indicating that the at least one of the WTRUs has been selected as the UE-to-NW relay for the FLC. The method may include receiving, from the at least one of the WTRUs, a local model update associated with the FLC.

Various embodiments may be directed to a method, which may be implemented in a network node or network function. For example, in some embodiments, the method may include any one or more of the steps performed by or associated with the PMF as discussed elsewhere herein, such as described in or with respect to FIGS. 7-11. It should also be understood that one or more of the steps of the method may be optional, may be omitted, and/or may be performed in a different order.

In an embodiment, the method may include determining, by a network node or network function, one or more direct discovery instructions for at least one WTRU. The method may include sending a message, to the at least one WTRU, the message indicating any of: (i) the direct discovery instructions determined for the at least one WTRU, (ii) an identifier of a WTRU which is to be discovered by the at least one WTRU or which will discover the at least one WTRU, (iii) an identifier of a ProSe application server, (iv) ProSe application code and/or ProSe restricted code, and/or (v) an expiration time for each of the direct discovery instructions.

Various embodiments may be directed to a method, which may be implemented in a first wireless transmit/receive unit (WTRU). For example, in some embodiments, the method may include any one or more of the steps performed by or associated with FLC1 and/or UE1 as discussed elsewhere herein, such as described in or with respect to FIGS. 7-11. It should also be understood that one or more of the steps of the method may be optional, may be omitted, and/or may be performed in a different order.

In an embodiment, the method may include receiving, by a WTRU from a network node, a message indicating direct discovery instructions determined for the WTRU, and any of: (i) an identifier of a WTRU which is to be discovered by the at least one WTRU or which will discover the at least one WTRU, (ii) an identifier of a ProSe application server, (iii) ProSe application code and/or ProSe restricted code, and (iv) an expiration time for each of the direct discovery instructions. The method may then include performing direct discovery procedure(s) according to the direct discovery instructions and/or any of the other information received in the message from the network node.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
[1] 3GPP TS 23.501 V16.4.0 (2020-03); System architecture for the 5G System (5GS); Stage 2 (Release 16).
[2] 3GPP TS 23.288 V17.5.0 (2022-06), “Architecture Enhancements for 5G System (5GS) to Support Network Data Analytics Services (Release 17),” June 2022
[3] 3GPP TS 22.261 V19.0.0 (2022-09), “Service Requirements for the 5G system; Stage 1 (Release 19)”, September 2022.
[4] 3GPP TR 23.700-80 V1.0.0 (2022-09), “Study on 5G System Support for AI/ML-based Services (Release 18),” September 2022.
[5] 3GPP TR 22.876 V0.1.0 (2022-09), “Study on AI/ML Model Transfer-Phase 2 (Release 19),” September 2022.
[6] 3GPP TS 23.304 V17.4.0 (2022-09), Proximity based Services (ProSe) in the 5G System (5GS) (Release 17)
[7] 3GPP TR 23.700-33 V1.1.0 (2022-10), Study on system enhancement for Proximity based Services (ProSe) in the 5G System (5GS); Phase 2 (Release 18).

LISTING OF POSSIBLE ABBREVIATIONS AND TERMS

| | |
|---|---|
| 3GPP | 3rd Generation Partnership Project |
| 5G | 5th Generation |
| 5G DDNMF | 5G Direct Discovery Name Management Function |
| 5GC | 5G Core Network |
| 5GS | 5G System |
| 6G | 6th Generation |
| 6GC | 6G Core Network |
| 6GS | 6G System |
| AF | Application Function |
| AMF | Access and Mobility Management Function |
| AUSF | Authentication Server Function |
| FL | Federated Learning |
| FLC | Federated Learning Client |
| FLS | Federated Learning Server |
| NF | Network Function |
| NRF | Network Repository Function |
| NW | Network |
| NWDAF | Network Data Analytics Function |
| PCF | Policy Control Function |
| PMF | Proximity Management Function |
| ProSe | Proximity based Service |
| SA | Service Architecture |
| UDM | Unified Data Management |
| UDR | Unified Data Repository |
| UDSF | Unstructured Data Storage Function |
| UE | User Equipment. |

1. A first wireless transmit/receive unit (WTRU), comprising:
circuitry, including any of a processor, memory, transmitter and receiver, configured to:
send, to a network node, first information indicating a request for at least one other WTRU to serve as a relay WTRU for the first WTRU;
receive, from the network node, second information indicating one or more candidate relay WTRUs in proximity of the first WTRU;
based at least on the second information, select at least one of the candidate relay WTRUs to serve as the relay WTRU for the first WTRU;
perform, according to a discovery mode, a discovery procedure with the at least one selected relay WTRU;
send third information indicating a direct communication request to the at least one selected relay WTRU;
perform a local training round to generate a new local model update; and
send fourth information, to the at least one selected relay WTRU, indicating at least a portion of the new local model update and an identifier of a federated learning (FL) task associated with the new local model update.

2. The first WTRU of claim 1, wherein the first WTRU comprises a federated learning client (FLC).

3. The first WTRU of claim 1, wherein the at least one other WTRU comprises a second WTRU and a third WTRU.

4. The first WTRU of claim 1, wherein the first information further indicates any of: (i) an identifier associated with a federated learning (FL) task, (ii) an identifier associated with the first WTRU, (iii) an identifier associated with each of one or more of the at least one other WTRU that is in proximity of the first WTRU, and (iv) an identifier associated with a group head of a group that the first WTRU belongs to.

5. The first WTRU of claim 1, wherein the second information further indicates any of: (i) an identifier associated with the network node, (ii) an identifier associated with a FL task running at the first WTRU; (iii) an identifier associated with each of the one or more candidate relay WTRUs, and (iv) a discovery mode for performing discovery between the first WTRU and one or more of the candidate relay WTRUs.

6. The first WTRU of claim 1, wherein the third information further indicates any of: (i) information indicating a smart contract address associated with the first WTRU, (ii) information indicating the identifier of the FL task, (iii) information indicating an expected size of a local model update, (iv) information indicating an expected frequency of sending the local model update to the at least one selected relay WTRU, (v) information indicating the identifier of the network node, and (vi) information indicating an expected time to finish a current local training round.

7. The first WTRU of claim 1, wherein the circuitry is configured to receive fifth information, from the at least one selected relay WTRU, indicating that the direct communication request has been authorized.

8. The first WTRU of claim 1, wherein the circuitry is configured to determine to send the request for the least one other WTRU to serve as a relay WTRU for the first WTRU based on any of: (i) sensing that the first WTRU's uplink has a degraded communication quality, and (ii) a preference to reduce energy consumption in uploading the first WTRU's local model update to the network node.

9. A method, implemented by a first wireless transmit/receive unit (WTRU), the method comprising:
sending, to a network node, first information indicating a request for at least one other WTRU to serve as a relay WTRU for the first WTRU;
receiving, from the network node, second information indicating one or more candidate relay WTRUs in proximity of the first WTRU;
based at least on the second information, selecting at least one of the candidate relay WTRUs to serve as the relay WTRU for the first WTRU;
performing, according to a discovery mode, a discovery procedure with the at least one selected relay WTRU;
sending third information indicating a direct communication request to the at least one selected relay WTRU;
performing a local training round to generate a new local model update; and
sending fourth information, to the at least one selected relay WTRU, indicating at least a portion of the new local model update and an identifier of a federated learning (FL) task associated with the new local model update.

10. The method of claim 9, wherein the first WTRU comprises a federated learning client (FLC).

11. The method of claim 9, wherein the at least one other WTRU comprises a second WTRU and a third WTRU.

12. The method of claim 9, wherein the first information further indicates any of: (i) an identifier associated with a federated learning (FL) task, (ii) an identifier associated with the first WTRU, (iii) an identifier associated with each of one or more of the at least one other WTRU that is in proximity of the first WTRU, and (iv) an identifier associated with a group head of a group that the first WTRU belongs to.

13. The method of claim 9, wherein the second information further indicates any of: (i) an identifier associated with the network node, (ii) an identifier associated with a FL task running at the first WTRU; (iii) an identifier associated with each of the one or more candidate relay WTRUs, and (iv) a discovery mode for performing discovery between the first WTRU and one or more of the candidate relay WTRUs.

14. The method of claim 9, wherein the third information further indicates any of: (i) information indicating a smart contract address associated with the first WTRU, (ii) information indicating the identifier of the FL task, (iii) information indicating an expected size of a local model update, (iv) information indicating an expected frequency of sending the local model update to the at least one selected relay WTRU, (v) information indicating the identifier of the network node, and (vi) information indicating an expected time to finish a current local training round.

15. The method of claim 9, comprising receiving fifth information, from the at least one selected relay WTRU, indicating that the direct communication request has been authorized.

16. The method of claim 9, comprising determining to send the request for the least one other WTRU to serve as a relay WTRU for the first WTRU based on any of: (i) sensing that the first WTRU's uplink has a degraded communication quality, and (ii) a preference to reduce energy consumption in uploading the first WTRU's local model update to the network node.

17. An apparatus, comprising:
circuitry, including any of a processor, memory, transmitter and receiver, configured to:
determine to select a wireless transmit/receive unit (WTRU)-to-network (NW) relay for a federated learning client (FLC);
send, to a network node, first information indicating a request for proximity information and context information associated with the FLC;
receive, from the network node, second information indicating: (i) the proximity information and context information associated with the FLC, and (ii) one or more WTRUs in proximity of the FLC that support WTRU-to-NW relay services;
based at least on the second information, select at least one of the WTRUs to serve as a WTRU-to-NW relay for the FLC;
send, to the at least one of the WTRUs, third information indicating that the at least one of the WTRUs has been selected as the WTRU-to-NW relay for the FLC; and
receive, from the at least one of the WTRUs, a local model update associated with the FLC.

18. (canceled)

19. (canceled)

20. (canceled)

21. (canceled)

22. (canceled)
